(19) United States
(12) Patent Application Publication
(10) Pub. No.: US 2013/0268522 A1
(43) Pub. Date: Oct. 10, 2013

(54) SYSTEM AND METHOD FOR CONTENT EXCLUSION FROM A MULTI-DOMAIN SEARCH

(71) Applicant: Timothy A. Barrett, Pymble (AU)

(72) Inventor: Timothy A. Barrett, Pymble (AU)

(73) Assignee: THOMSON LICENSING, Issy de Moulineaux (FR)

(21) Appl. No.: 13/805,697

(22) PCT Filed: Jun. 28, 2010
(86) PCT No.: PCT/IB12/01562

§ 371 Date: Dec. 20, 2012

(51) Int. Cl. G06F 17/30

(52) U.S. Cl. CPC G06F 17/3053
USPC 707/723

(57) ABSTRACT

A system and method for content exclusion from a multi-domain search, where search results are prioritized or potentially excluded based on content provided by a service provider. The system and method provide for providing access to a network by a primary service provider, the network including multiple sources of content; receiving at least one search parameter; performing a search for content based on the received at least one search parameter; prioritizing results of the search based on content provided by the primary service provider; and displaying the prioritized results. In one embodiment, the system and method further includes excluding at least one search result if the at least one search result matches content provided by the primary service provider.

### TECHNICAL FIELD OF THE INVENTION

The present disclosure generally relates to digital content systems and methods for searching through a large amount of media content from a range of different sources efficiently and more particularly, to a system and method for content exclusion from a multi-domain search, where search results are prioritized or potentially excluded based on content provided by a service provider.

### BACKGROUND OF THE INVENTION

Home entertainment systems, including television and media centers, are converging with the Internet and providing access to a large number of available sources of content, such as video, movies, TV programs, music, etc. This expansion in the number of available sources necessitates a new strategy for navigating a media interface associated with such systems and making content selections.

In a service where a user searches for content, this is typically done in such a way that the search results are provided from a single domain. For example, a Google™ search for “Forrest Gump” would illustrate all references to Forrest Gump on the Internet, whereas a search for “Forrest Gump” on a video service, such as provided by Netflix™, Inc. of Los Gatos, Calif., would only provide matches of the title in the Netflix™ catalogue.

In an instance where a platform were to provide a unified search across multiple other service provider's content, i.e., a multi-domain search, providing search results gets complex, as search results would contain matches from a number of service providers, and without any additional processing, the search results would be ordered according to the relevance of the match.

As models emerge where a service provider may support content from other service providers, this model gets even more complex. There is a value proposition for a service provider to provide content from multiple other service providers to give customers more choice. This, however, goes against the model of a service provider selling their own content.

Therefore, a need exists for techniques for performing a unified search across multiple domains while maintaining the value of a commercial service delivering content.

### SUMMARY

A system and method for content exclusion from a multi-domain search are provided. Searches are performed across multiple domains, i.e., in a user's home, on a device, on the Internet and as part of a service. The present disclosure provides a mechanism whereby the system and method will prioritize results for paid content provided as part of the service, and potentially exclude alternative matching search results for similar content in the event that paid versions are available. While content on a user's local network would always be displayed, matches available at low or no cost from the internet, for example, could be excluded from the search results displayed to the user. The system and method may further include providing a mechanism to allow results displayed in a search to be controlled such that, if, for example, multiple versions of particular titles are found, and one of those instances is a commercial title available from the provider's service, only the commercial title will be shown in the result. In another embodiment, presentation of search results will be done with prioritization of results rather than active filtering of non-commercial versus commercial content.

According to one aspect of the present disclosure, a method for searching for content across multiple domains is provided, the method including providing access to a network by a primary service provider, the network including multiple sources of content, receiving at least one search parameter, performing a search for content based on the received at least one search parameter, prioritizing results of the search based on content provided by the primary service provider, and displaying the prioritized results.

According to another aspect of the present disclosure, a system for searching for content includes a receiver circuit that provides access to a network by a primary service provider, the network including multiple sources of content, a user interface that receives at least one search parameter, a controller coupled to the receiver circuit and user interface that performs a search for content based on the received at least one search parameter and prioritizing results of the search based on content provided by the primary service provider, and a display interface coupled to the controller that displays the prioritized results.

### BRIEF DESCRIPTION OF THE DRAWINGS

These, and other aspects, features and advantages of the present disclosure will be described or become apparent from the following detailed description of the preferred embodiments, which is to be read in connection with, the accompanying drawings.

In the drawings, wherein like reference numerals denote similar elements throughout the views:

FIG. 1 is a block diagram of an exemplary system for delivering video content in accordance with the present disclosure;

FIG. 2 is a block diagram of an exemplary set-top box/digital video recorder (DVR) in accordance with the present disclosure;

FIG. 3 is a perspective view of an exemplary remote controller in accordance with an embodiment of the present disclosure;

FIG. 4 illustrates an exemplary embodiment of an apparatus for searching for content in accordance with the present disclosure;

FIG. 5 is a flowchart of an exemplary method for searching for content in accordance with an embodiment of the present disclosure;

FIG. 6 illustrates search results in accordance with an embodiment of the present disclosure;

FIG. 7 illustrates an exemplary embodiment of a user interface of the present disclosure;

FIGS. 8A and 8B illustrate initial search screens of the user interface of the present disclosure;

FIG. 9 illustrates how various axes of the user interface represents search criteria relating to a central starting point of the content search;

FIG. 10 illustrates a method for determining additional information associated with a selected graphical element and for further searching using the selected element; and

FIG. 11 is a flowchart of an exemplary method for searching for content in accordance with an embodiment of the present disclosure.

It should be understood that the drawings are for purposes of illustrating the concepts of the disclosure and is not necessarily the only possible configuration for illustrating the disclosure.

### DETAILED DESCRIPTION OF PREFERRED EMBODIMENTS

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

In order to provide a high value service to end consumers, it is desirable for a video delivery service to provide access to a broad range of content, and have search results from not only the service itself, but also content available from a wide variety of services such as local devices in the consumers home and a range of sources on the internet, including “Over the Top” service providers. i.e., a multi-domain search. This, however, goes against the model of a service provider selling their own content as part of a service.

The present disclosure provides a system and method for content exclusion from a multi-domain search, where search results are prioritized or potentially excluded based on a service provider and what content is available in which domain. The present disclosure provides a mechanism whereby the system and method will prioritize results for paid content provided as part of the service, and potentially exclude alternative matching search results for similar content in the event that paid versions are available. The present disclosure enables results displayed in a search to be controlled such that, if, for example, multiple versions of particular titles are found, and one of those instances is a commercial title available as part of a service, only the commercial title will be shown in the result. While content on the user's local network would always be displayed, matches available at low or no cost from the internet, for example, could be excluded from the search results displayed to the user.

Initially, systems for delivering various types of content to a user will be described. Subsequently, a method for searching the content in accordance with embodiments of the present disclosure will then be detailed.

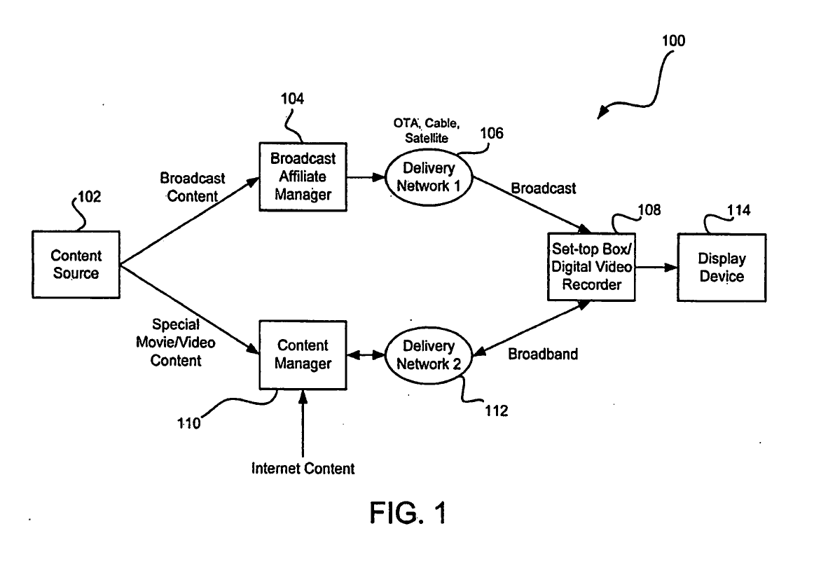

Turning now to FIG. 1, a block diagram of an embodiment of a system 100 for delivering content to a home or end user is shown. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager may collect and store the content, and may schedule delivery of the content over a deliver network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a user's set top box/digital video recorder (DVR) 108 in a user's home, where the content will form part of the results of subsequent searches by the user.

A second form of content is referred to as special content. Special content may include content that may have been delivered as premium viewing, pay-per-view, or other content otherwise not provided to the broadcast affiliate manager. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system, or explicitly into the search only such that content may be searched that has not yet been delivered to the user's set top box/digital video recorder 108. The content manager 110 may deliver the content to the user's set top box/digital video recorder 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of Delivery network 1 (106). In addition, the user may also obtain content directly from the Internet via delivery network 2 (112) without necessarily having the content managed by the content manager 110.

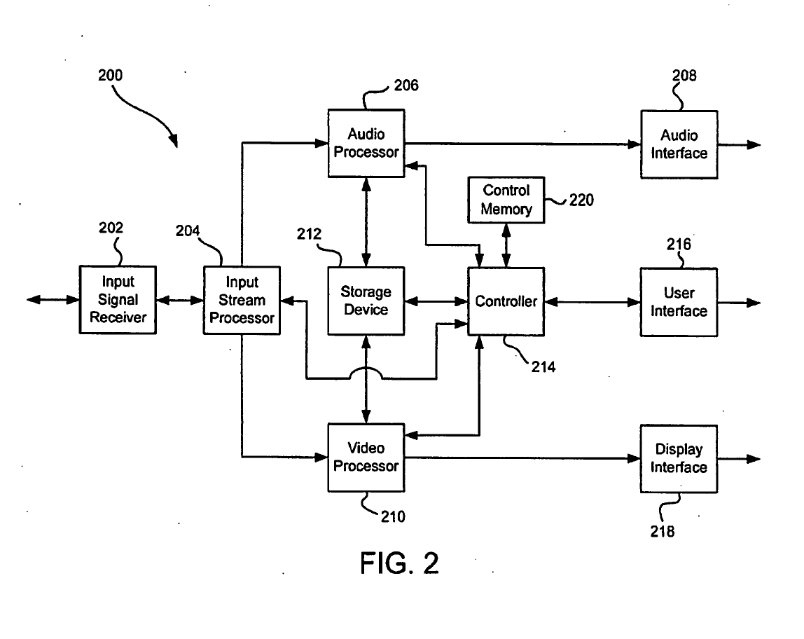

The set top box/digital video recorder 108 may receive different types of content from one or both of delivery network 1 and delivery network 2. The set top box/digital video recorder 108 processes the content, and provides a separation of the content based on user preferences and commands. The set top box/digital video recorder may also include a storage device, such as a hard drive or optical disk drive, for recording and playing back audio and video content. Further details of the operation of the set top box/digital video recorder 108 and features associated with playing back stored content will be described below in relation to FIG. 2. The processed content is provided to a display device 114. The display device 114 may be a conventional 2-D type display or may alternatively be an advanced 3-D display. It should be appreciated that other devices having display capabilities such as wireless phones, PDAs, computers, gaming platforms, remote controls, multi-media players, or the like, may employ the teachings of the present disclosure and are considered within the scope of the present disclosure.

Turning now to FIG. 2, a block diagram of an embodiment of the core of a set top box/digital video recorder 200 is shown. The device 200 shown may also be incorporated into other systems including the display device 114 itself. In either case, several components necessary for complete operation of the system are not shown in the interest of conciseness, as they are well known to those skilled in the art.

In the device 200 shown in FIG. 2, the content is received in an input signal receiver 202. The input signal receiver 202 may be one of several known receiver circuits used for receiving, demodulation, and decoding signals provided over one of the several possible networks including over the air, cable, satellite, Ethernet, fiber and phone line networks. The desired input signal may be selected and retrieved in the input signal receiver 202 based on user input provided through a control interface (not shown). It is to be appreciated that the input signal receiver 202 may in certain embodiments be a transceiver for two way communication to and from the set top box/digital video recorder 108. In certain embodiments, the transceiver will output information, e.g., a search request to delivery network 2 (112) to search for Internet content.

The decoded output signal from the input signal receiver 202 is provided to an input stream processor 204. The input stream processor 204 performs the final signal selection and processing, and includes separation of video content from audio content for the content stream. The audio content is provided to an audio processor 206 for conversion from the received format, such as compressed digital signal, to an analog waveform signal. The analog waveform signal is provided to an audio interface 208 and further to the display device 114 or an audio amplifier (not shown). Alternatively, the audio interface 208 may provide a digital signal to an audio output device or display device using an HDMI (High-Definition Multimedia Interface) cable or alternate audio interface such as via a SPDIF (Sony/Philips Digital Interconnect Format). The audio processor 206 also performs any necessary conversion for the storage of the audio signals.

The video output from the input stream processor 204 is provided to a video processor 210. The video signal may be one of several formats. The video processor 210 provides, as necessary a conversion of the video content, based on the input signal format. The video processor 210 also performs any necessary conversion for the storage of the video signals.

A storage device 212 stores audio and video content received at the input. The storage device 212 allows later retrieval and playback of the content under the control of a controller 214 and also based on commands, e.g., navigation instructions such as fast-forward (FF) and rewind (Rew), received from a user interface 216. The storage device 212 may be a hard disk drive, one or more large capacity integrated electronic memories, such as static random access memory, or dynamic random access memory, or may be an interchangeable optical disk storage system such as a compact disk drive or digital video disk drive.

The converted video signal, from the video processor 210, either originating from the input or from the storage device 212, is provided to the display interface 218. The display interface 218 further provides the display signal to a display device of the type described above. The display interface 218 may be an analog signal interface such as red-green-blue (RGB) or may be a digital interface such as high definition multimedia interface (HDMI). It is to be appreciated that the display interface 218 will generate the various screens for presenting the search results in a three dimensional array as will be described in more detail below.

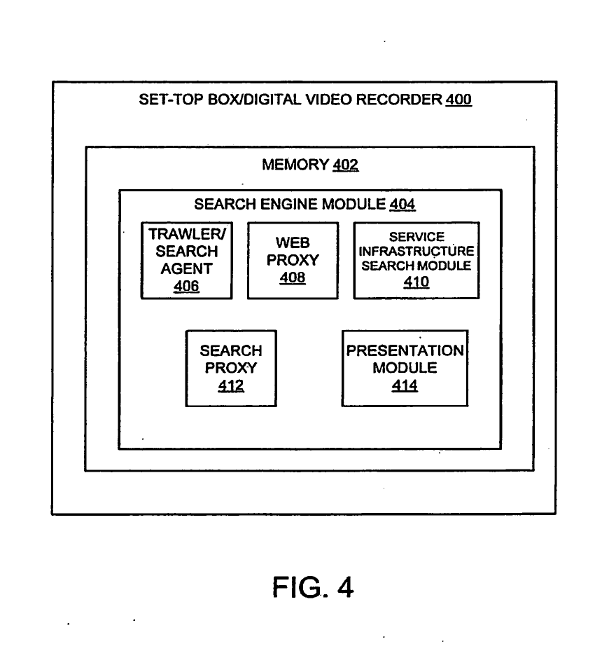

The controller 214 is interconnected via a bus to several of the components of the device 200, including the input stream processor 202, audio processor 206, video processor 210, storage device 212, and a user interface 216. The controller 214 manages the conversion process for converting the input stream signal into a signal for storage on the storage device or for display. The controller 214 also manages the retrieval and playback of stored content. Furthermore, as will be described below in relation to FIG. 4, the controller 214 performs searching of content, either stored or to be delivered via the delivery networks described above. The controller 214 is further coupled to control memory 220 (e.g., volatile or non-volatile memory, including random access memory, static RAM, dynamic RAM, read only memory, programmable ROM, flash memory, EPROM, EEPROM, etc.) for storing information and instruction code for controller 214. Further, the implementation of the memory may include several possible embodiments, such as a single memory device or, alternatively, more than one memory circuit connected together to form a shared or common memory. Still further, the memory may be included with other circuitry, such as portions of bus communications circuitry, in a larger circuit.

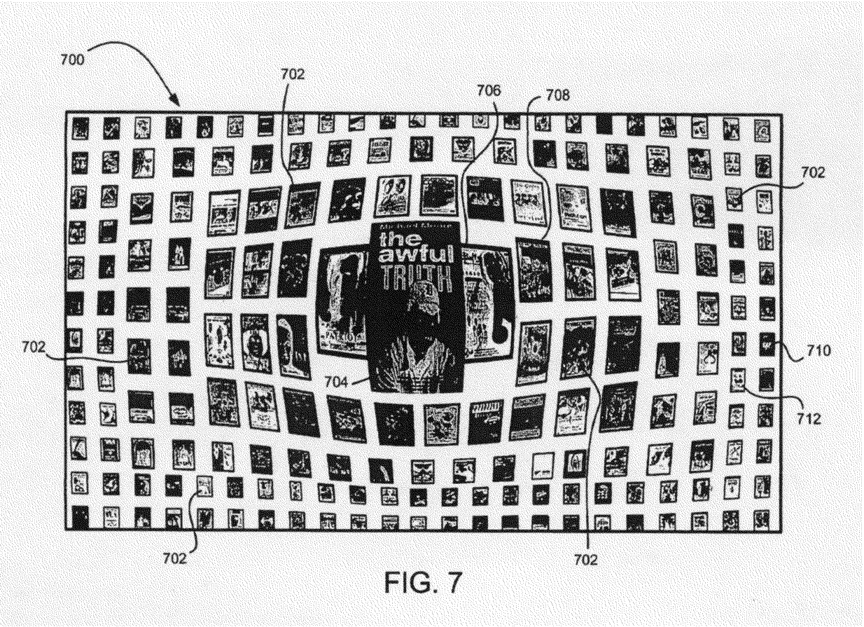

The search results may be abstracted from the presentation of the results (user interface 216), so that in search entry and results may be based on anything from a traditional search box to enter search criteria, and a list in response, an entirely graphical model where the search is conducted based on graphical elements, and results are displayed in a similar fashion. In one such embodiment, data could be presented in a visual form, distributing images representing in 3 dimensions on the screen, with the various axes representing criteria that relate to a starting point, and the proximity to the central point indicates the relevance to the search. The outer bounds of the screen will contain a large amount of varied material of various types to allow the user to select content of a different type. Such a user interface will be described in detail below with reference to FIGS. 7-11.

To operate effectively, the user interface 216 of the present disclosure employs an input device. In one embodiment, the input device is a remote controller, with a form of motion detection, such as a gyroscope or accelerometer, which allows the user to move a cursor freely about a screen or display. In another embodiment, the input device is a controller in the form of a touch pad or touch screen remote that takes movements on the user's finger and translates this to the position of a cursor on the screen, or alternatively be used to provide a virtual keyboard. In other embodiments, the controller may include a full keyboard for typing search entries and also may include an accelerometer/gyroscope to track the user's movement to allow selection of elements to act as keys for a search. Other types of input devices such as conventional remotes, wireless devices such as phones and PDAs, motion capture devices or the like are also considered within the scope of the present disclosure.

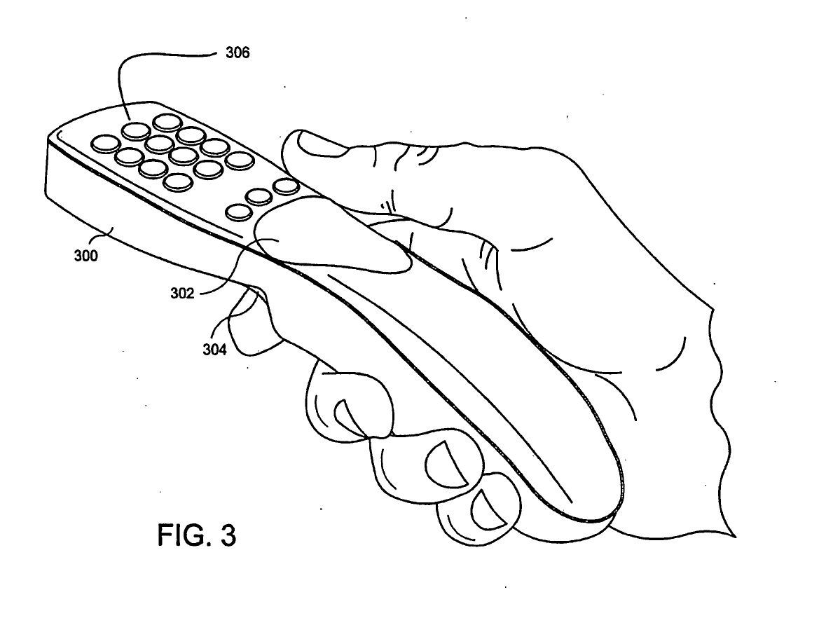

An exemplary hand-held angle-sensing remote controller 300 is illustrated in FIG. 3. Remote controller 300 includes a thumb button 302, positioned on the top side of controller 300 so as to be selectively activated by a user's thumb. Activation of thumb button 302 will also be referred to as a “click,” a command often associated with activation or launch of a selected function. Controller 300 further includes a trigger button 304, positioned on the bottom side of controller 300 so as to be selectively activated by a user's index (or “trigger”) finger. Additionally, a plurality of buttons 306 are provided for entering numbers and/or letters. In one embodiment, the plurality of buttons 306 is configured similar to a telephone-type keypad.

In addition to traditional controls for video playback, the remote controller device 300 may also include a mechanism to invoke at least three separate options on any element highlighted on the display or screen. These options may be referred to as “Additional Information”, “Play” and “Additional Search”. It is to be appreciated that these three options may be associated with predefined or new gestures or each option may be assigned to a predetermined button of the plurality of buttons 306 on the remote controller 300.

It is to be appreciated that at least some of the components described above in relation to FIGS. 1-3 will form a system for generating the user interface and for searching for content across multiple domains. An exemplary system for searching for content includes the display interface 218 for displaying search results which are prioritized based on content provided by a primary service provider.

The system and method of the present disclosure provide a unified user experience across all domains of application, game or content playback capability. Whereas traditional platforms only provide content search across a single service, the system and method of the present disclosure provide search and content access across the following domains:

1) Video Service Content

2) Live Video Content (via a Electronic Program Guide (EPG))

3) Locally Stored Content (e.g., on a personal video recorder or PVR) or USB Attached, or Copied Media

4) Local Network Available Content (e.g. DLNA (Digital Living Network Alliance) shared content), which may be available from multiple servers in the home.

5) NSP (Network Service Provider) Content services

6) Custom Local Network Non-DLNA Content (e.g., iTunes, etc)

7) Specific Free Internet Service content (e.g. Youtube)

8) Specific Commercial over-the-top (OTT) Service Offerings (e.g. Netflix, Unbox, Blockbuster etc)

The search capability of the present disclosure will be provided through a number of mechanisms on the set top box/digital video recorder 400 as illustrated in FIG. 4. It is to be appreciated that the set top box/digital video recorder includes an operating system and/or a micro instruction code. The various processes and functions described herein may either be part of the micro instruction code or part of a software application program (or a combination thereof) which is executed via the operating system. In one embodiment, the software application program is tangibly embodied on a program storage device, which may be uploaded to and executed by any set top box/digital video recorder.

A software program includes a search engine module 404 stored in memory 402 for searching for content across multiple domains. It is to be appreciated that in one embodiment memory 402 is control memory 220 of FIG. 2 where the instructions stored thereon are executed by controller 214. In another embodiment, memory 402 and a corresponding processor or controller to perform the searching may be a separate, stand-alone integrated circuit such as a digital processing processor (DSP) or an application specific integrated circuit (ASIC).

The search engine module 404 includes a trawler/search agent 406 which indexes local and local network media. This media includes any locally stored content (such as that copied to the storage device 212 or available on local USB media), or on any discoverable media serving devices (such as DLNA servers on the network). Where possible, the trawler/search agent 406 will dynamically associate graphics and metadata with the content. This also includes content that may have no metadata (such as a filename on a USB media stick), in which case the agent 406 will search external sources to determine the title of the content using available information (such as filename and/or running time of the clip). Images and metadata will be cached on the local hard disk of set-top box/ digital video recorder 400. It is also possible for a user to manually associate graphics and metadata with a title.

A web proxy 408 is provided to allow the set top box/digital video recorder 400 to search content on the Internet, and only display appropriate data. In one embodiment, the web proxy 408 will be a scalable service that takes search requests and forwards them to traditional web search engines, then parses the results and passes back appropriate information (including metadata and graphics where possible) to a search proxy 412, which will be described below.

The search engine module 404 further includes a service infrastructure search module 410 providing search results with associated metadata and graphics associated with titles from Network Service Provider (NSP) Content Services, i.e., content from various network studios.

The search proxy 412 is a mechanism through which all searches will be conducted. When a search is initiated from the user interface 216, the search proxy 412 will forward the search to multiple endpoints via modules 406, 408, 410, then amalgamate or merge the results and feed them back to a search presentation module 414. In this way, the system of the present disclosure can provide access to a broad range of content, and have a search results displayed from not only a single service itself, but also content available from a wide variety of services such as local devices in the consumers home (via the search agent 406) and a range of sources on the internet (via web proxy 408).

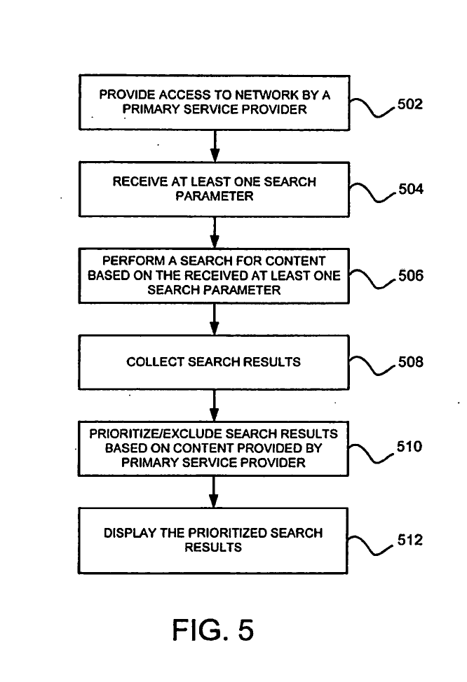

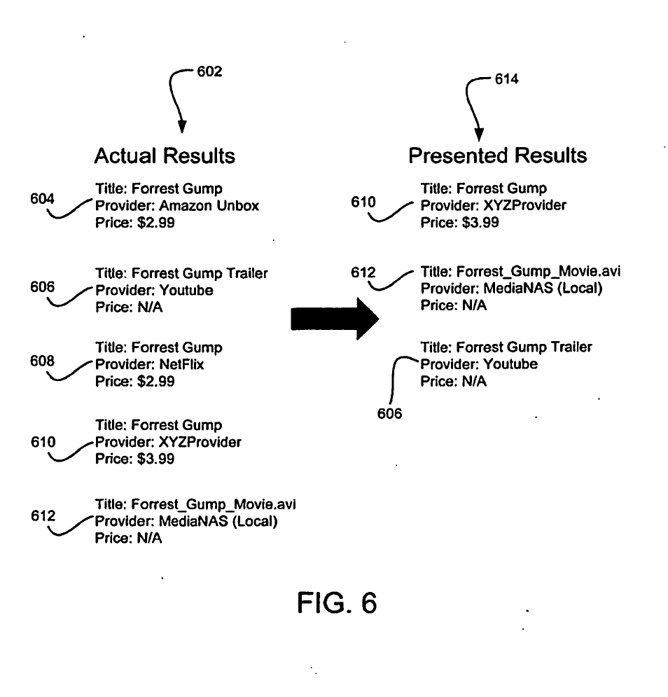

In addition to amalgamating the results, the search proxy 412 will prioritize the search results for paid content provided as part of the service, and potentially exclude alternative matching search results for similar content in the event that paid versions are available. While content on the user's local network may always be displayed, matches available at low or no cost from the Internet, for example, could be excluded from the search results displayed to the user. The details of the presentations of the search results will be described below in relation to FIGS. 5 and 6.

Lastly, the search engine module 404 includes the presentation module 414 for presenting the search results to a user on a screen or display. The results may be abstracted from the presentation of the results, so that in additional to a traditional search box to enter search criteria, and a list in response, an entirely graphical option will also be available. In the graphical mode, data is presented in a visual form, distributing images representing content in three dimensions on the screen, with the various axes representing criteria that relate to a starting point, and the proximity to the central point indicates the relevance to the search. The outer bounds of the screen will contain a large amount of varied material of various types to allow the user to select content of a different type.

A method for searching content in accordance with the present disclosure will now be described in relation to FIGS. 5 and 6, where FIG. 5 is a flowchart of an exemplary method for searching for content and FIG. 6 illustrates how actual search results are prioritized and/or excluded for presentation to a user.

Initially, in step 502, a primary service provider provides access to a network, e.g., via a set top box/digital video recorder 108, 200, 400. The network includes multiple sources of content including the content provided by the primary service provider, content provided by at least one secondary service provider, content found on the Internet and content locally stored on a user's device or other devices on the user's home network. In step 504, the search engine module 404 will receive at least one search parameter entered via the user interface.

. 25 The search proxy 412 performs the search based on the based on the received at least one search parameter via the trawler/search agent 406, web proxy 408 and services infrastructure search module 410, in step 506. Next, in step 508, the search proxy 412 collects the search results from the various domains.

Next, in step 510, the search proxy 412 will prioritize and/or exclude search results based on the content provided by the search provider that the user subscribes to. In an instance where a search across multiple domains results in the same content being made available from multiple service providers, a prioritization call is made to determine the order in which the content is displayed to the user, step 512. If the primary service provider had a paid version of the content matched in a search, and the same content was available from another secondary service provider, the primary service provider controlling the service would likely want to prioritize their own content over that of the other service providers. Further, in this instance, the search proxy 412 may filter out or exclude certain competitive offerings completely such that the results of the search favor the requirements of the service provider delivering the service.

In one embodiment, the search proxy 412 will determine if at least one returned search result matches content provided by the service provider delivering the service. If a matched is determined, the search proxy 412 will exclude the matched search result and only present to the user the content provided by the primary service provider delivering the service. In one embodiment, the search proxy 412 will determine a match by analyzing metadata associated to the search result or associated to the content itself. In this embodiment, a predefined search agent will be established for each secondary service to be search. In this manner, the metadata returned with the search results will come back in a predetermined format which will facilitate the determination of matching search results.

In another embodiment, if the metadata is not returned in a predetermined format, e.g., when searching locally stored content or on the Internet, the search proxy 412 will analyze the metadata to determine what type of content the search result relates to and if the search result is a match. For example, the search proxy 412 will determine if the content is a video by file type. If the search proxy 412 determines that the content is a video, the search proxy then analyzes other metadata, e.g., a length of the content, resolution of the content, etc., to determine if the content is a full length movie, a clip, trailer, or the like.

It is to be appreciated that the search results may be prioritized based on whether each individual search result is determined to be competitive to the primary service provider delivering the service. For example, if the user is searching for the full length version of a movie and the search proxy determines the search result is a trailer, the trailer will be deemed non-competitive to the service provider delivering the service, will be assigned a low priority, and will be presented to the user. In another embodiment, any short form clips deemed not to be the title itself, may form part of the “Additional Information” available from and associated with the main title. In a further example, locally stored content, whether on the user's set top box/digital video recorder, a USB drive, another device on the user's home network, etc., will be assigned a high priority and presented to the user.

In a further embodiment, although search results may be deemed competitive to the service provider delivering the service, the competitive search results may be presented to the user but at a lower priority, e.g., lower down a list when presented in such a format, or deeper in a list of available sources associated with the main title. For example, assuming the primary service provider delivering the service has partnered up with other or secondary service providers, if search results are returned with the same result from the primary service provider, i.e., the service provider delivering the service, and the secondary service provider, the result from the primary service provider will be listed first or presented as having the most relevance to the search. The result from the secondary service provider will be listed next and then other results such as for related clips, trailers or the like.

Referring to FIG. 6, an example of how actual search results are prioritized and/or excluded for presentation to a user by the system and method of the present disclosure is provided. In the example shown, the primary service provider is XYZProvider and the user performs a search for “Forrest Gump”. The actual results of the search for “Forrest Gump” are generally denoted by reference numeral 602. The first result 604 of the actual results 602 is a result for the movie “Forrest Gump” which is available for a price of $2.99 from a secondary service provider, i.e., Amazon™ Unbox. The second search result 606 is a Forrest Gump trailer, available at no cost from a free Internet content service provider, e.g., Youtube™. The third result 608 is a result for the movie “Forrest Gump” which is available for a price of $2.99 from another secondary service provider, i.e., NetFlix™. The fourth result 610 is a result for the movie “Forrest Gump” which is available for a price of $3.99 from the primary service provider, i.e., XYZProvider. Lastly, the fifth result 612 is a result for the movie “Forrest Gump” in an Audio Video Interleave (AVI) format which is locally stored and is available at no cost.

From the actual results 602, the search proxy 412 will prioritize and/or exclude certain results. For example, results 604 and 608 are determined to be the same content from competitive sources, i.e., secondary service providers, and therefore, are excluded from the presented results 614. The remaining results 606, 610 and 612 are then prioritized for presentation to the user. In this example, the search result 610 from the primary service provider is assigning the highest priority and is listed first in the results. The search result 612, which is locally stored content, is listed second. Lastly, the search result 606 of a trailer from the free Internet content service provider is listed last. It is to be appreciated that once the competitive search results are excluded, the prioritization of results can be performed or programmed in many ways, and presentation may include simply showing a single instance of the content in question and providing access to this additional content as a sub-menu.

It is further to be appreciated that the search and results do not necessarily need to be presented in a text-based form and may be presented in a three dimensional form. In an embodiment where, for example, a search was performed by clicking on an icon or element and the parameters of that icon or element were used to drive the search and the resulting screen was made up of icons or elements representing content associated with the parameters of the originally selected icon, the filtering and prioritization process may simply determine what content is displayed on a subsequent screen. In the event that the position of the icons or elements on the screen is used to represent associations between content, the results prioritization could also be used to represent relative position of content on the screen.

FIG. 7 illustrates a 3D user interface 700 in accordance with an embodiment of the present disclosure, where graphic elements or icons representing content are generally indicated by reference numeral 702. Interface 700 provides a mechanism for a user to browse or search through content and channels using graphic elements to represent the content. Instead of traditional search result pages containing five to ten lines of programs, interface 700 presents plurality (e.g., hundreds) of individual elements 702, each potentially having unique visual, spatial, and behavioral attributes representing available programming, channels, applications, music files, or some form of category thereof.

Elements 702 can be of minimal size to allow a maximum number of elements 702 to populate interface 700. In one embodiment, displayed elements 702 rely on a clear graphical element to represent content and content categories, ensuring a maximum number of elements 702 that could be displayed on one screen or display. Accordingly, moving a cursor of remote control 300 over the individual elements magnifies them (as shown in 704), and if the user pauses over a particular element for a short period of time, for example, ½ second, additional information will be shown such as a title, actors performing in the content, the director, etc.

All elements 702 are of similar proportions, however, elements 702 are visually differentiated through their size and position relative to the central element 704 and graphical representations, elements or signifying symbols in order to help a user identify a particular category of content or particular title of interest. Elements 706, 708 near the center of the screen are larger and have a greater association with content at the center of the screen, e.g., element 704, than those towards the edges of the screen, where the content displayed will be increasingly more random and have significantly smaller elements, e.g., elements 710, 712.

The design layout of the elements on the screen will imply depth, with the largest element in the center of the screen, e.g., element 704 in FIG. 7, having the highest priority and elements closer to the periphery of the screen getting smaller and appearing further away, e.g., elements 710, 712, such elements having a lower priority. The spacing between elements when moving towards the periphery will also be reduced to further indicate depth. When the user moves the cursor over an element, it is enhanced. In displaying content elements, it is possible that the image of one element will obscure that of another, in particular when the user expands an element by moving over it. For example, in FIG. 7, when element 704 is expanded it obscures or partially overlaps element 706.

Elements 702 may represent an individual piece of content, such as a movie, which, if selected and then actioned in the right way will play. In this instance, the element may be, for example a representation of the DVD cover of the title in question. The same element, if selected in a different way, such as with a search button on the remote controller 300 as opposed to a play button, would perform an entirely different action, using the data associated with it as the source for a search for related content. The data used in the search could include a variety of criteria including the content's genre, actors, directors, or other data such as “friends recommendations”, etc. The elements may also be used to represent applications, TV channels or other content, though in this case they are not likely to be a recognizable DVD cover, but rather something more directly associated with the content.

Any element may be made up of images representing the content, such as a defined frame from a piece of recorded content, an image supplied from the network or by the user, or from a library of generic elements either manually or automatically assigned to the content. Any of these elements may be augmented with text, either overlaid on the element itself or displayed along with it, and/or additional smaller elements to indicate the type of content. For example, elements representing content that is locally stored on the device 108, 200 may be presented with a small element of a disk drive in the bottom right hand corner of a larger image representing the content itself.

Elements 702 are configured to be detailed enough for a user to clearly see the type of content they represent. Elements 702 could also be in part or fully dynamically created, such as including elements of content currently playing on a broadcast channel. For example, an element may be dynamically generated (either locally or delivered from the network) of a scene from recently broadcast video, then combined with a logo or some indication of the source of the content, e.g., from the primary service provider, locally stored, etc.

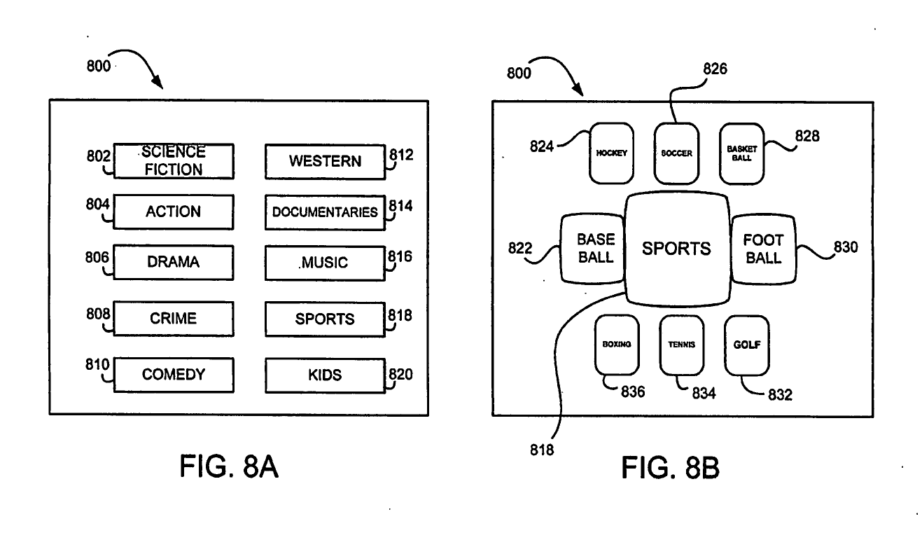

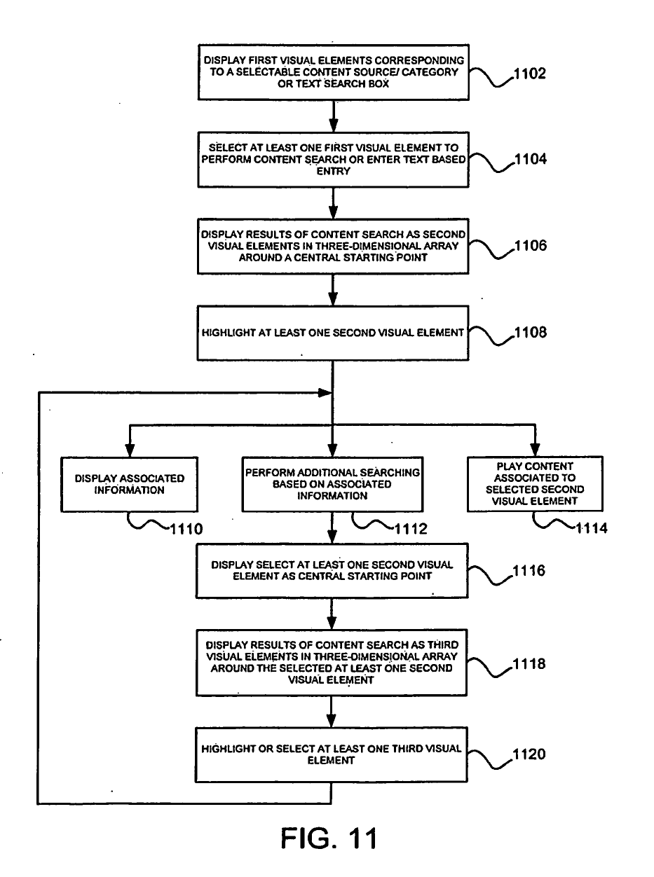

A method for searching content using a 3D user interface in accordance with the present disclosure will now be described in relation to FIGS. 8 through 11, where FIGS. 8A, 8B, 9 and 10 illustrate exemplary screens or display of the user interface and FIG. 11 is a flowchart of an exemplary method for searching for content.

Referring to FIGS. 8A, 8B and 11, an initial screen 800 with a number of first elements that in essence represent, by association, all content that needs to be accessible to the user is provided to a user upon the user beginning to search (step 1102). Alternatively, the initial screen may allow for a text based entry to begin the search, e.g., a text search box.

In one embodiment, the key broad categories take up the middle of the screen providing very recognizable and easy to select elements to provide the first, broad- brush search, e.g., categories or sources of content. In this instance, many of the elements would be generic, representing specific genres. For example, there may be a specific element for specific genres such as science fiction 802, action movies 804, drama 806, crime 808, comedy 810, westerns 812, documentaries 814, music 816, sport 818, kids 820, etc. and, when selected, will have a title of appropriate genre placed at the centre of the screen, and a next level of detail of generic thumbnails displayed at the edge of the screen. For example, for the first level, the user may select the generic Sport element 818 in FIG. 8A. The second level then displays the selected element 818 at the center of the display 800 and displays a generic thumbnail or element for various types of sport movies such as baseball movies 822, hockey movies 824, soccer movies 826, basketball movies 828, football movies 830, golf movies 832, tennis movies 834 and boxing movies 836.

In one embodiment, the initial screen may be as represented in FIG. 7, where instead of particular titles being predominant, the center of the screen is predominantly populated with thumbnails or elements clearly representing generic categories. In this embodiment, the visual elements include both elements relating to specific content and to a variety of categories. The positioning of the elements in this embodiment may be based on user preferences, e.g., user selected preferences, preferences determined by the controller based on prior viewed selections, etc. In this embodiment, the user may select particular content to be played or executed directly from the initial screen or display without performing further searching.

The layout of the initial screen 800 could be based on a number of factors including preferences, random selection, previous buying habits or buying profile. In one embodiment, the initial screen will be determined by the primary service provider. In such an embodiment, the content in the middle of the initial screen will tend to be type of content the user has watched in the past. The initial screen is to represent, as much as possible, all possible content choices available to the user, which could also imply that a large amount of high-level categories may be displayed. In one embodiment, this could be as broad as elements representing “Broadcast” content, “Movies”, “Documentaries”, “Applications” and “Games”. In this embodiment, these broad categories could also have other elements interspersed that may be, for example, current particularly popular movies, the user's favorite channels, or generic elements representing movie genres such as “Sci-fi”. Elements may also be generated for external streaming services such as Youtube, for individual pieces of content on those servers or for content locally available on the device or local network, such as pre-recorded content, allowing any of these services to be searched explicitly.

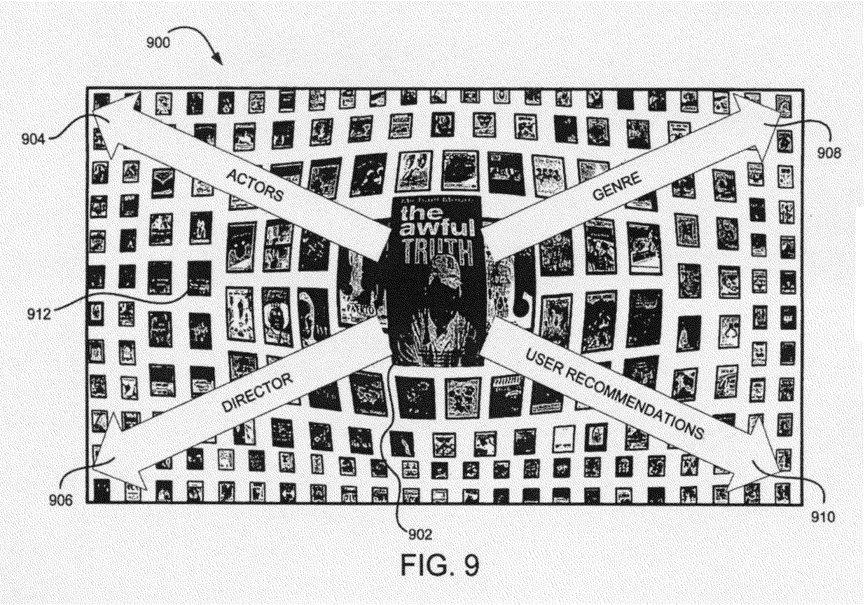

Once the user has selected a content source or category or entered a text entry (step 1104) for search, the user will be presented the results of the search as a plurality of second visual elements in a three dimensional array on the display 900, as shown in FIGS. 7 and 9 (step 1106). Each visual element on the secondary screen may still correspond to generic categories (as determined by the search), or, more frequently to a specific piece of content, wherein at least one axis of the display 900 represents search criteria relating to a central starting point 902 of the three dimensional array and proximity of each of the second visual elements to the central starting point indicates a degree of relevance to the search.

Referring to FIG. 9, the axes 904-910 on the screen may all be used to represent categories of association with the content represented by the element at the center of the screen 902, i.e., the content having the highest priority. These axes may vary according to implementation and there may be more than just diagonal axes defined. In one embodiment, the axes could represent, actors along a first diagonal (to top left) 904, directors down a second diagonal (to bottom left) 906, genre up a third diagonal (to top right) 908, and “people that like this content also liked . . .” down a forth diagonal (to bottom right) 910. For example, as a user moves the cursor, in response to movement of the input device, the cursor will highlight, e.g., expand, various elements. As the cursor moves along axis 904, the user interface will display elements of content that either have the same actors as in the content represented by the central element 902 or will display elements of content that have some relationship or association to the actor in the content represented by the central element 902. As a further example, if the user moves the cursor over content elements, e.g., element 912, between axis 904 and axis 906, the user interface will display elements of content that share an association to actors appearing in and the director of the content represented by the central element 902.

In another embodiment, the axes may represent the sources of the content. For example, one axis may represent content from the primary service provider. Another axis may represent content from secondary service providers. Yet another axis may represent content locally stored. A further axis may represent content from free Internet service content providers. It is to be appreciated that the central point or element 902 will have the highest priority assigned to it and elements extending toward the periphery will have decreasing priorities assigned.

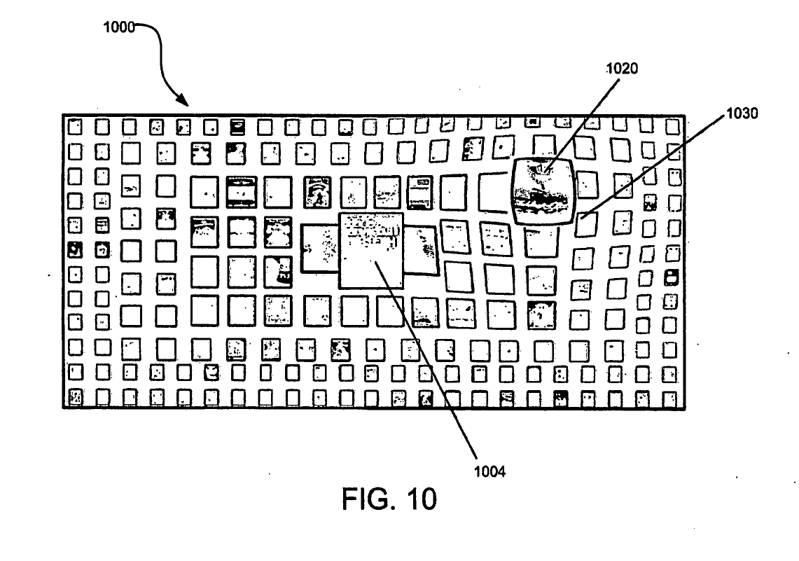

Referring to FIGS. 10 and 11, in step 1108, in a typical embodiment, a user highlights one of elements presented in the search results by using a pointing device such as a the hand-held remote controller 300 described above. When the user moves over an element, the element is expanded in-situ, as illustrated by highlighted element 1020. More specifically, the display area associated with highlighted element 1020 is also enlarged and additional content associated with highlighted element 1020 is displayed to provide the user with more information about the highlighted or selected source. Elements proximate to selected element 1020 are also visually expanded to a lesser extent as illustrated by proximate elements 1030, such that proximate elements 1030 closest to selected element 1020 are largest in size, but smaller than element 1020. The progressive expansion of elements proximate to selected element 1020 may be referred to as “hyperbolic expansion”. In one embodiment, progressive expansion is vertically and horizontally, but in other embodiments may be only horizontal or vertical. It may also include, as an example, a type of lens distortion effect as if the element 1020 is being placed under a magnifying glass. Individual elements may be highlighted by moving the cursor in both horizontal (x) and vertical (y) dimensions or any degree of either of these dimensions.

Once an element is highlighted, e.g., element 1020, it may be selected for further action by clicking on an action button on the remote controller 300 or by performing an appropriate gesture with the remote controller 300. In one embodiment, there are at least three main actions: to display information associated to the content (step 1110); to search again using data from the highlighted element 1020 as a search key (step 1112), or to go directly to play or execute that piece of content associated to the highlighted or selected element (step 1114). Other embodiments may also include options such as to play or purchase the content, get additional information, add it to a favorites list, etc.

When the option to display associated information is selected (step 1110), the user interface will provide additional information regarding the highlighted content. This information associated with the expanded elements may include text (such as a title of the content, actors appearing in, the director, etc.), labels, advertisements, media, graphics, animation, applications, links and video, or combinations thereof.

When functions such as ‘play’ or ‘tune to’ are invoked (step 1114), the action will take place immediately in association with the current enlarged focus element 1020. For more complex or multi-step functions such as record, remind, rate this, and block/restrict, subsequent user actions are required. These subsequent user actions are facilitated by menus or step-through interactive sequences. These menus or step-through interactive sequences may appear as pop-up or floating panels, with a variety of text instructions, questions, or choices, and active elements representing selectable options.

The user may also select the option to perform further searching based on the highlighted or selected element (step 1112). To perform the further searching, the information associated to the selected content element will be employed for the search criteria. Once the results of the search are determined and prioritized, the display or screen will be re-drawn with the selected element having the highest priority as the central starting point (step 1116). The user interface will then display the results of the search as a plurality of third visual elements in a three dimensional array on the display surrounding the previously selected element (step 1118). In step 1120, the user may then select or highlight one of the displayed elements and the user will then have the option to perform at least one of the actions described above in steps 1110, 1112 and 1114.

Although embodiments which incorporate the teachings of the present disclosure have been shown and described in detail herein, those skilled in the art can readily devise many other varied embodiments that still incorporate these teachings. Having described preferred embodiments of a system and method for content exclusion from a multi-domain search (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. A method for searching for content across multiple domains, the method comprising:
providing access to a network by a primary service provider, the network including multiple sources of content;
receiving at least one search parameter;
performing a search for content based on the received at least one search parameter;
prioritizing results of the search based on content provided by the primary service provider; and
displaying the prioritized results.

2. The method as in claim 1, wherein the multiple sources of content include the content provided by the primary service provider, content provided by at least one secondary service provider, content found on the Internet and content locally stored on a user's device.

3. The method as in claim 1, further comprising excluding at least one search result if the at least one search result matches content provided by the primary service provider and displaying the search result of the content provided by the primary service provider.

4. The method as in claim 3, further comprising determining matches of search results based on metadata associated to each content.

5. The method as in claim 4, wherein the metadata associated to each content includes a type of file of the content, a length of the content and a resolution of the content.

6. The method as in claim 1, further comprising:
determining a source for each content of the search results;
excluding at least one search result if the at least one search result matches content provided by the primary service provider, wherein the source of the at least one search result is at least one secondary service provider; and
displaying the search result of the content provided by the primary service provider.

7. The method as in claim 6, wherein if the source of the at least one search result is locally stored content, assigning a high priority to the at least one search result.

8. The method as in claim 7, wherein if the source of the at least one search result is a free Internet content service provider, assigning a low priority to the at least one search result.

9. The method as in claim 1, wherein the prioritizing step includes:
determining if at least one search result from at least one secondary service provider matches content provided by the primary service provider; and
if the at least one search result from at least one secondary service provider matches content provided by the primary service provider, assigning a higher priority to the content provided by the primary service provider.

10. The method as in claim 1, wherein the prioritizing Step includes:
determining if at least one search result from at least one secondary service provider matches content provided by the primary service provider; and
if the at least one search result from at least one secondary service provider matches content provided by the primary service provider, excluding the at least one search result from at least one secondary service provider if the associated content is available at no cost.

11. A system for searching for content comprising:
a receiving circuit that provides access to a network by a primary service provider, the network including multiple sources of content;
a user interface that receives at least one search parameter;
a controller coupled to the receiving circuit and the user interface, the controller performing a search for content based on the received at least one search parameter and prioritizing results of the search based on content provided by the primary service provider; and
a display interface coupled to the controller the display interface displaying the prioritized results.

12. The system as in claim 11, wherein the multiple sources of content include the content provided by the primary service provider, content provided by at least one secondary service provider, content found on the Internet and content locally stored on a user's device.

13. The system as in claim 11, wherein the controller also excludes at least one search result if the at least one search result matches content provided by the primary service provider and the display interface displays the search result of the content provided by the primary service provider.

14. The system as in claim 13, wherein the controller also determines matches of search results based on metadata associated to each content.

15. The system as in claim 14, wherein the metadata associated to each content includes a type of file of the content, a length of the content and a resolution of the content.

16. The system as in claim 11, wherein the controller also determines a source for each content of the search results and excludes at least one search result if the at least one search result matches content provided by the primary service provider, wherein the source of the at least one search result is at least one secondary service provider; and the display interface displays the search result of the content provided by the primary service provider.

17. The system as in claim 16, wherein if the source of the at least one search result is locally stored content, the controller assigns a high priority to the at least one search result.

18. The system as in claim 17, wherein if the source of the at least one search result is a free Internet content service provider, the controller assigns a low priority to the at least one search result.

19. The system as in claim 11, wherein the controller also determines if at least one search result from at least one secondary service provider matches content provided by the primary service provider and, if the at least one search result from at least one secondary service provider matches content provided by the primary service provider, assigns a higher priority to the content provided by the primary service provider.

20. The system as in claim 11, wherein the controller determines if at least one search result from at least one secondary service provider matches content provided by the primary service provider and if the at least one search result from at least one secondary service provider matches content provided by the primary service provider, excludes the at least one search result from at least one secondary service provider if the associated content is available at no cost.

21. A system for searching for content across multiple domains, the system comprising:
means for providing access to a network by a primary service provider, the network including multiple sources of content;
means for receiving at least one search parameter;
means for performing a search for content based on the received at least one search parameter;
means for prioritizing results of the search based on content provided by the primary service provider; and
means for displaying the prioritized results.
